(19) United States
(12) Patent Application Publication
(10) Pub. No.: US 2010/0215977 A1
(43) Pub. Date: Aug. 26, 2010

(54) Method of Mounting Conductors on a Plastic Part

(76) Inventors: Markus Pfletschinger, Eningen (DE); Bernd Schwarz, Walddorfhaelach (DE); Jan Krueger, Stuttgart (DE); Ingmar Petersen, Esslingen (DE)

Correspondence Address: KF ROSS PC, 5683 RIVERDALE AVENUE, SUITE 203 BOX 900, BRONX, NY, 10471-0900, US

(21) Appl. No.: 11/989,107

(22) PCT Filed: Apr. 10, 2006
(86) PCT No.: PCT/EP2006/003250

§ 371 Date: Oct. 27, 2009

(30) Foreign Application Priority Data
Jul. 21, 2005 (DE) 10 2005 034 085.7

(51) Int. Cl. B60R 16/02; B29C 70/72

(52) U.S. Cl. 428/548; 156/245

(57) ABSTRACT

The invention relates to a method for applying electrical conductor patterns (1) to or into a target component (10) of plastic, it being provided according to the invention that a carrier medium on or in which the conductor patterns (1) are permanently arrange d is placed in a mould part (3, 8) and the mould part (3, 8) is filled with a mouldable polymer material, the target component (9) with the conductor patterns (1) being removed from the mould part (3, 8) after the moulding of the polymer material.

### TECHNICAL FIELD

The invention relates to a method of mounting electrical conductors on a part made of plastic in accordance with the features of the introductory clause of

### PRIOR ART

Producing parts made of plastic is known. Thus it is known, for instance, to produce flat motor-vehicle parts such as engine hoods, roofs, trunk lids, and the like from plastic in order to reduce weight. Similarly, vehicle body parts such as fenders, doors, bumpers, and the like can be made of plastic. In addition to the reduction in weight, these parts made of plastic have the advantage that, compared to parts made of steel, they cannot rust.

Moreover, also known for such parts of vehicles is inserting or adding electrically conducting structures (conductors) that transmit energy or signals. Methods known in the past are used for applying the conductors, in which methods first the part is produced so that it attains its final shape. The conductors are not applied until after this, for instance by clipping on wires or punched, bent parts. However, such a method of subsequently applying the conductors is disadvantageous since a complex matching process is required between the material for the conductor and the target material and the service life required for the conductors on the part during subsequent vehicle operation is not assured. In addition, it is disadvantageous that a complex assembly process is required. Furthermore, there are major problems with mounting conductors to the part post manufacture because as a rule the latter is complex, for instance arcuate, curved, or the like. The result of this is that subsequent application of conductors is very complex, if it is possible at all.

### DESCRIPTION OF THE INVENTION

The basic object of the invention is therefore to provide a method of mounting electrical conductors on a part made of plastic that is simple to realize and that avoids the disadvantages described above. In addition, the method should produce a part having electrical conductors.

This object is attained using the features of patent claim 1.

In accordance with the invention a substrate, on or in which the conductors are permanently arranged, is placed in a mold and the mold is filled with a moldable plastic material, the part with the conductors being removed from the mold after molding.

In a further development of the invention, the substrate is placed into the mold such that it is completely surrounded by the plastic material and thus is imbedded in the part. This has the advantage that the conductors are thus also completely surrounded by the material for the part and are therefore mounted therein in a protected manner. Such a variant is provided when the conductors transmit current and/or signals and the conductors are made accessible e.g. at the edge or at another location from the surface of the part. The same applies when the conductors are used for antenna structures that receive and/or transmit high frequency signals. These are then arranged in the part of the vehicle in a protected manner. It is not necessary for a transparent material to be used for the plastic material, but instead it can be colored corresponding to the color of the installation location for the part. However, if a transparent plastic material is used, it is possible for the conductors to be antenna structures or even heat conductors if the part is a windshield for the vehicle.

In one alternative version of the invention, the substrate is placed into the mold such that it forms one surface of the part, at least in part. This means that the substrate, which can no longer be removed from the part, itself forms a portion of a surface of the part, the conductors themselves being arranged in a protected manner between the surface of the part that faces the substrate and the substrate itself. Such a construction can be used for instance when the part is subject to different requirements from its different sides at its installation location. An example of this is a vehicle roof where the plastic material to be added to the mold is selected such that it satisfies the requirements for the exterior plastic roof, while the substrate is for instance the material for a roof lining for the interior of the vehicle. Thus conductors, for instance for transmitting energy or for antenna structures, can be arranged in a particularly advantageous manner between the vehicle roof and the roof lining and such a vehicle roof can be produced in one step in the manner of a sandwich.

In another version of the invention, after manufacture of the part the conductors are exposed, at least in part, on the surface thereof. That is, the substrate is placed into the mold such that the conductors are not surrounded, at least are not completely surrounded, in particular are not surrounded at all, by the plastic material to be added in. After the finished part has been removed from the mold, the conductors are exposed, at least in part, in particular completely, on its surface and can be subjected to further processing. They can then be provided with electrical or electronic components for performing the functions of an electronic device or some of the functions thereof, and can be provided with means that form a plug-in connector.

### BRIEF DESCRIPTION OF THE DRAWING

Embodiments of the invention are described in the following and explained with reference to the figures, the invention not being limited thereto.

FIG. 1 shows electrical conductors applied to a is substrate;

FIG. 2 shows a mold for receiving the substrate;

FIG. 3 shows the closed mold after the foamable plastic material has been added;

FIG. 4 shows the part with remaining substrate;

FIG. 5 shows another embodiment of a mold and the addition of the plastic material, which in this instance is not foamable.

### WAYS OF CARRYING OUT THE INVENTION

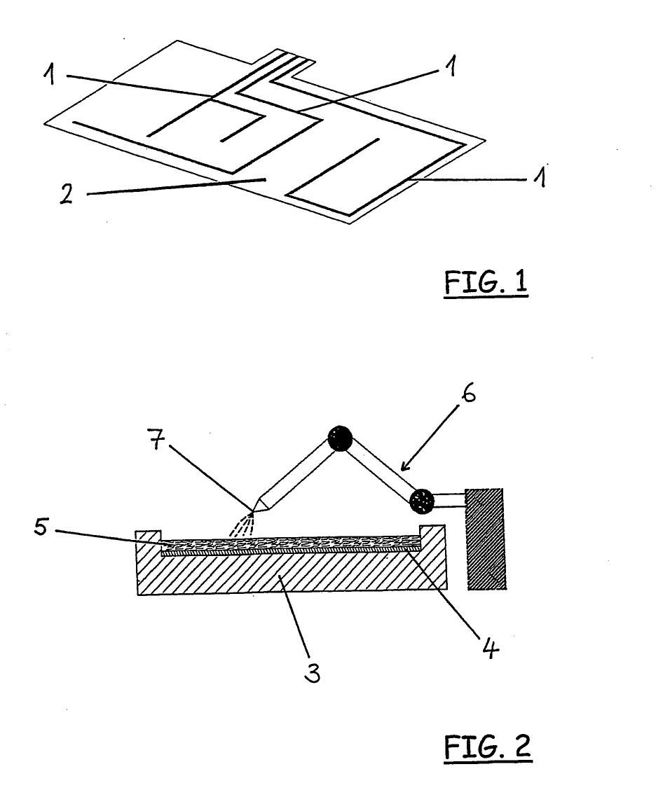

FIG. 1 shows conductors 1 that are applied to a substrate, in particular a thin film 2.

Conductors that can be used include pastes, such as silver polymer pastes, Cu pastes (copper), or the like. The substrate can be PET, PMMU (Plexiglass), PC (polycarbonate), PP (polypropylene), and other plastic films or fiber composites that can bond with the surrounding plastic, regardless of whether they are foamable or injectable, can be used for the substrate, in particular for films. The conductors can be applied to the film by screen printing, pad printing, and all common printing methods that can also be used with color (spraying or sputtering). The above-described lists are only examples and are not comprehensive.

The film 2 shown in FIG. 1 having conductors 1 attached thereto either already has the final shape of the part that is finished later or can be brought to its final shape prior to or during manufacture of the part or after its manufacture.

FIG. 2 shows a mold for holding the substrate. The mold generally comprises two or more parts so that it is possible to place the substrate into the mold. In this embodiment, there is a first mold part 3 to which is applied a paint layer, in particular a paint film 4. This paint layer can be present, but is not essential. A foamable plastic (foam layer 5) is placed in the first mold part 3 by an application tool 6 after the paint layer has been added, or if the latter is not there, is added first. The foamable plastic material is applied to the first mold part 3 in a flat manner or in another manner, e.g. by a nozzle 7 of the application tool 6. The foamable plastic material should be matched to the paint film 4 with consideration to compatibility and coefficient of expansion. The coefficients of expansion for the paint film 4 and foam should be precisely matched to one another so that there is no bimetal effect.

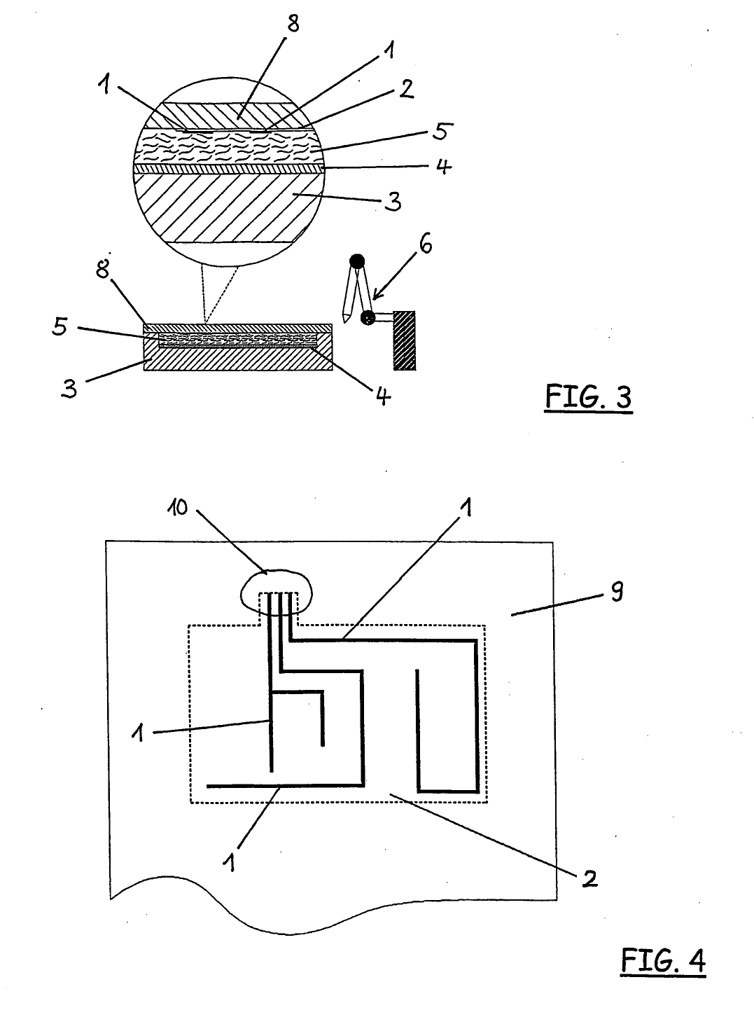

FIG. 3 shows the closed mold after the foamable plastic material has been added. Once the foamable plastic material has been added to the first mold part 3, the mold is sealed, in this case by an additional mold part 8. Prior to sealing, the substrate (film 2 with applied conductors 1 in accordance with FIG. 1) is added to the mold. It can be placed onto the foam layer 5 or adhered to the interior of the additional mold part 8. As an alternative, the substrate can be formed by the additional mold part 8, which then bears the conductors 1 and which is a part thereof after the part is produced. Once the mold has been closed, the foam layer 5 begins to swell, resulting in heat and pressure, such that either the conductor 1 is foamed onto the film 2 or the conductor 1 is foamed onto the mold part 8. In this process, the quantity of the plastic material added is selected such that the entire interior of the mold, including the conductors placed inside (and any film 2 placed inside) is completely filled during foaming. If a greater quantity is selected, it might be necessary to add an outlet aperture to the mold

FIG. 4 shows a segment of the finished part, and illustrates that the conductors 1 permanently adhered to the foam layer 5, can no longer be removed from the substrate (in this case the film 2, alternatively e.g. the mold part 8), but rather has become a single unit. Thus the conductors 1 are at least partly exposed, are entirely exposed, or are completely embedded and can be subjected to further processing, in particular painting or attachment of electrical or electronic parts or the like.

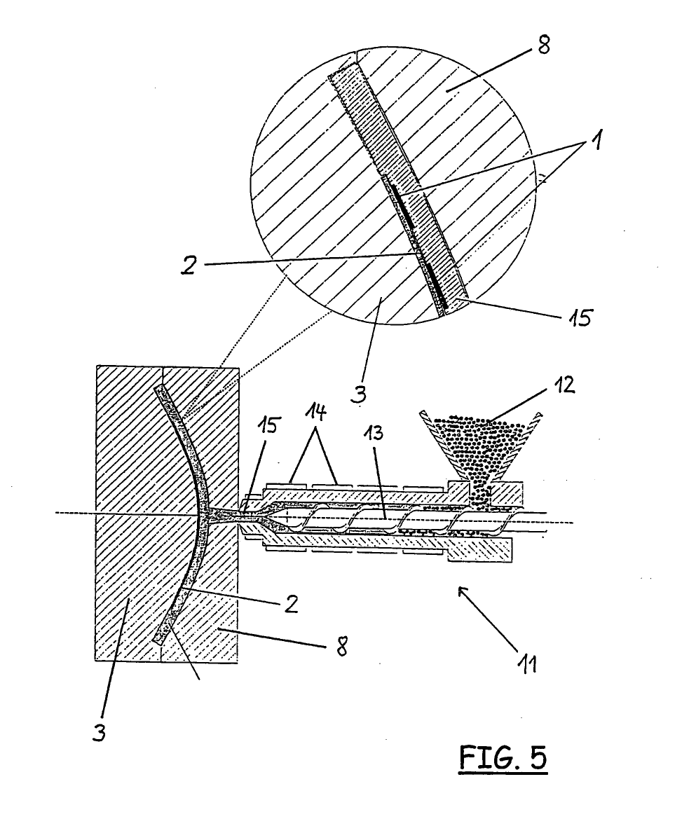

FIG. 5 shows another version of a mold and the addition of the plastic material (not foamable, in this case) for producing a part. After the substrate has been prepared with conductors in accordance with FIG. 1, it is placed in a mold that in this illustrated version also comprises the first mold part 3 and at least the additional mold part 8. This mold is a part of or is attached to an extruder 11, known per se, the moldable plastic material being supplied in the form of granulate 12 to the mold via a worm 13. While being fed, the granulate 12 is heated via heating means 14 so that at the end of the extruder 11 a heated plastic melt 15 can be supplied to the mold via a corresponding fill opening therein. The plastic melt 15 fills the interior free space of the mold 3, 8 and simultaneously surrounds the substrate, and, if the conductors 1 are oriented inward, also surrounds these conductors 1. This can be seen in the detail view in FIG. 5. At this point it should be noted that the film 2 with the conductors 1 arranged thereupon or therein is not necessarily required to be arranged on the surface of one of the mold parts 3, 8, but can also be arranged in the free space formed by the mold 3, 8 such that it is surrounded, in part or completely, by the plastic melt 15. Once the heated plastic melt 15 has hardened, the part (see FIG. 5) can be removed from the mold and processed further.

At this point it should be noted that after the part 9 has been removed, it has its final shape or can be calibrated. It is advantageous for it to be processed such that a contacting area 10 results at the end of the individual conductors 1.

Reference list
1 Conductors
2 Film
3 First mold part
4 Paint film
5 Foam layer
6 Application tool
7 Nozzle
8 Additional mold part
9 Part
10 Contacting area
11 Extruder
12 Granulate
13 Worm
14 Heating means
15 Heated plastic melt

1. A method of mounting electrical conductors on or in a part made of plastic, the method comprising the steps of:
applying a paste to a substrate to permanently fix thereon antenna-forming electrical conductors;
placing the substrate with the permanently fixed conductors in a mold;
filling the mold on at least one side of the substrate with a moldable and hardenable plastic material; and
hardening the material and adhering it to the side of the substrate to form the part; and
thereafter removing the part with the conductors from the mold.

2. The method in accordance with claim 1, wherein the substrate is placed in the mold such that it and the conductors are completely imbedded in the plastic material and thus are imbedded in the part.

3. The method in accordance with claim 1, wherein the substrate is placed in the mold such that it forms at least a portion of one outer surface of the part.

4. The method in accordance with claim 3, wherein after removal from the mold of the part the conductors are at least partially exposed on the surface of the part.

5. The method in accordance with claim 1 wherein hot molten plastic is the plastic material.

6. The method in accordance with claim 1 wherein a foamable plastic is the plastic material.

7. The method in accordance with any claim 1 wherein the substrate is a flexible film.

8. The method in accordance with any claim 1 wherein the substrate is a part of the mold.

9. A part produced according to the method in accordance of claim 1.

10. The part in accordance defined in claim 9, used as a part of a vehicle.

11. The part in accordance with claim 10, wherein the part of the vehicle is a fender, vehicle roof, trunk lid, bumper, windshield, or housing for an electronic device that is built into the vehicle.
